(19) United States
(12) Patent Application Publication
(10) Pub. No.: US 2007/0231008 A1
(43) Pub. Date: Oct. 4, 2007

(54) DRIVING FORCE TRANSMITTING DEVICE AND IMAGE FORMING DEVICE

(75) Inventor: Kimiaki Furukawa, Shizuoka-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/694,567

(22) Filed: Mar. 30, 2007

(30) Foreign Application Priority Data
Apr. 3, 2006 (JP) 2006-101716

(51) Int. Cl. G03G 15/00

(52) U.S. Cl. 399/167

(57) ABSTRACT

The present invention provides a technology capable of inhibiting generation of errors in a rotational speed of each gear resulted from form errors thereof in a driving force transmission using a plurality of gears.

The present invention comprises a first gear rotationally driven by a transmitted driving force, the first gear in which a plurality of first dimension setting units providing a predetermined effect to a dimension of the first gear in a radial direction of rotation are provided in different positions of the first gear in a rotational direction, and a second gear rotationally driven by a driving force which is transmitted from the first gear when the second gear meshes with the first gear, the second gear in which a plurality of second dimension setting units providing the predetermined effect to a dimension of the second gear in a radial direction of rotation are provided in positions of the second gear in a rotational direction, the positions where the second dimension setting units are in phase with the first dimension setting units at the time the second gear meshes with the first gear.

### BACKGROUND OF THE INVENTION

1. Field of the Invention

The present invention relates to a driving force transmitting technology using gears. In particular, the present invention relates to inhibition of a speed error resulted from a form error in each gear in a driving force transmission using a plurality of gears.

2. Description of the Related Art

There is known a driving force transmitting device transmitting a driving force from a predetermined driving source to a target driving object by using a plurality of gears (so-called gear train).

For example, in case where the driving force transmitting device described above is applied to a configuration which requires precise rotational drive, such as rotational drive of a photoconductor drum in a quadruple tandem type image forming device, each of a plurality of the photoconductor drums needs to be rotationally driven in a same angular speed.

However, when generally- and frequently-used resin-molded gears are used, errors may occur in a rotational speed transmitted between gears placed adjacent to each other due to a dimensional error in a radial direction resulted from heat contraction, etc. at the time of resin molding. In many cases, the dimensional error in a radial direction resulted from heat contraction such as above is generated corresponding to positions of ribs, notches, and resin injection gates of each gear.

### SUMMARY OF THE INVENTION

An object of embodiments of the present invention is to provide a technology capable of inhibiting generation of errors in a rotational speed resulted from a form error of each gear in driving force transmission using a plurality of gears.

In order to achieve the above object, according to an aspect of the present invention, there is provided a driving force transmitting device comprising: a first gear rotationally driven by a transmitted driving force, the first gear in which a plurality of first dimension setting units providing a predetermined effect to a dimension of the first gear in a radial direction of rotation are provided in different positions of the first gear in a rotational direction; and a second gear rotationally driven by a driving force which is transmitted from the first gear when the second gear meshes with the first gear, the second gear in which a plurality of second dimension setting units providing the predetermined effect to a dimension of the second gear in a radial direction of rotation are provided in positions of the second gear in a rotational direction, the positions where the second dimension setting units are in phase with the first dimension setting units at the time the second gear meshes with the first gear.

In addition, according to an aspect of the present invention, there is provided an image forming device, which forms an image to a sheet by rotationally driving a plurality of photoconductor drums, each of which forms a toner image of a color different from one another, the image forming device comprising: a first gear rotationally driven by a transmitted driving force, the first gear in which a plurality of first dimension setting units providing a predetermined effect to a dimension of the first gear in a radial direction of rotation are provided in different positions of the first gear in a rotational direction; a second gear rotationally driving a first photoconductor drum by a driving force, which is transmitted from the first gear when the second gear meshes with the first gear, the second gear in which a plurality of second dimension setting units providing the predetermined effect to a dimension of the second gear in a radial direction of rotation are provided in positions of the second gear in a rotational direction, the positions where the second dimension setting units are in phase with the first dimension setting units at the time the second gear meshes with the first gear; and a third gear rotationally driving a second photoconductor drum by a driving force, which is transmitted from the first gear when the third gear meshes with the first gear, the third gear in which a plurality of third dimension setting units providing the predetermined effect to a dimension of the third gear in a radial direction of rotation are provided in positions of the third gear in a rotational direction, the positions where the third dimension setting units are in phase with the first dimension setting units at the time the third gear meshes with the first gear.

In addition, according to an aspect of the present invention, there is provided a driving force transmitting device comprising: a first gear rotationally driven by a transmitted driving force, the first gear in which a plurality of first dimension setting means providing a predetermined effect to a dimension in a radial direction of rotation of the first gear are provided in different positions of the first gear in a rotational direction; and a second gear rotationally driven by a driving force which is transmitted from the first gear when the second gear meshes with the first gear, the second gear in which a plurality of second dimension setting means providing the predetermined effect to a dimension of the second gear in a radial direction of rotation are provided in positions of the second gear in a rotational direction, the positions where the second dimension setting means are in phase with the first dimension setting means at the time the second gear meshes with the first gear.

### BRIEF DESCRIPTION OF THE DRAWINGS

FIG. 1 is an entire configuration diagram for describing an image forming device of the present embodiment;

FIG. 2 is a view showing a configuration of a gear train (driving force transmitting device) for rotationally driving photoconductor drums 202Y to 202K;

FIG. 3 is a view showing a detail of relationships between an idler gear 103 and a drum gear 303, and a drum gear 304;

FIG. 4 is a view showing a state in which three notches 101k are provided at different positions of an idler gear 101′ in a rotational direction, as an example of providing notches; and

FIG. 5 is a timing chart showing that an exposure start timing in the photoconductor drum of each color is provided so as to be shifted from one another for six cycles of a motor gear 401.

### DETAILED DESCRIPTION OF THE PREFERRED EMBODIMENTS

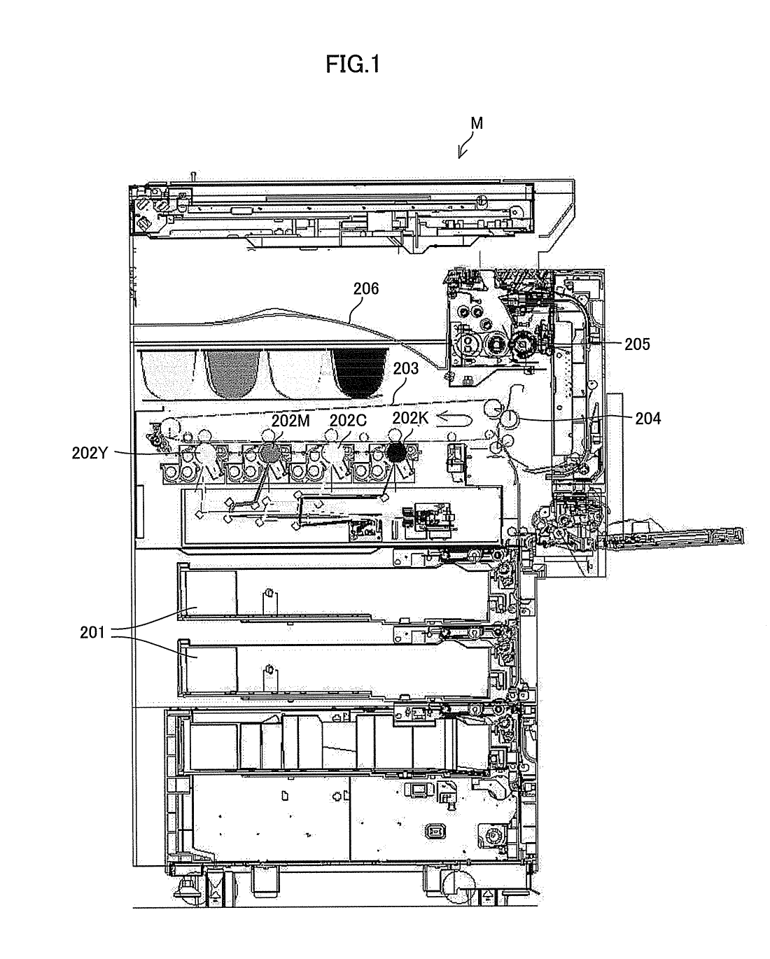

Hereinafter, an embodiment of the present invention will be described with reference to accompanying drawings. FIG. 1 is an entire configuration diagram for describing an image forming device of the present embodiment.

An image forming device M of the present embodiment is configured with, for example, an MFP (Multi Function Peripheral). The image forming device M includes a cassette 201, a photoconductor drum 202Y, a photoconductor drum 202M, a photoconductor drum 202C, a photoconductor drum 202K, an intermediate transfer belt 203, a secondary transfer roller 204, a fixing unit 205, and a delivery tray 206.

First, a sheet is supplied from the cassette 201 to a sheet conveying path. The photoconductor drums 202Y to 202K form a toner image on a belt surface of the intermediate transfer belt 203. The toner image formed on the intermediate transfer belt 203 is transferred to the sheet by the secondary transfer roller 204. Thereafter, the sheet to which the toner image is transferred is conveyed to the fixing unit 205, and the toner image is heated and fixed. The sheet on which the toner image is heated and fixed is ejected to the delivery tray 206, and the image forming process is completed.

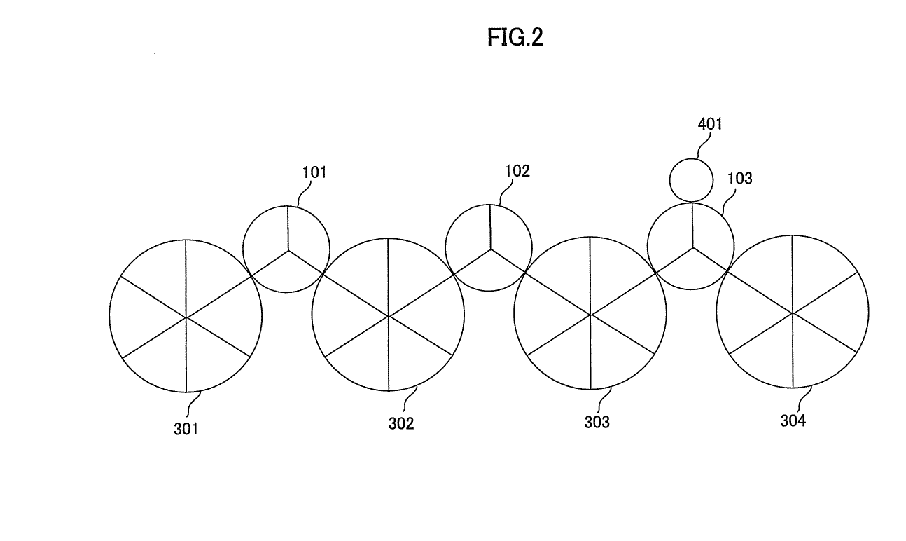

Subsequently, a driving system of the photoconductor drums 202Y to 202K will be described. FIG. 2 is a view showing a configuration of a gear train (driving force transmitting device) for rotationally driving the photoconductor drums 202Y to 202K. A drum gear 301, a drum gear 302, a drum gear 303 (corresponding to a second gear), and a drum gear 304 (corresponding to a third gear) are provided to the photoconductor drum 202Y, the photoconductor drum 202M, the photoconductor drum 202C, and the photoconductor drum 202K, respectively. Each of the drum gears is provided integrally to the photoconductor drum on the same axis of the rotational axis of the photoconductor drum in a rotatable manner. The present embodiment is configured with photoreceptors which are rotationally driven by a driving force being transmitted to the drum gears,

In addition, an idler gear 101, an idler gear 102, and an idler gear 103 (corresponding to a first gear) are placed between each of the drum gears 301 to 304. With a configuration such as the one above, a driving force transmitted from a motor gear 401 of one motor (driving source) is configured to transmit to four of the drum gears through the idler gears. The drum gears 301 to 304 and the idler gears 101 to 103 are resin-molded by using, for example, a resin material of plastic, etc.

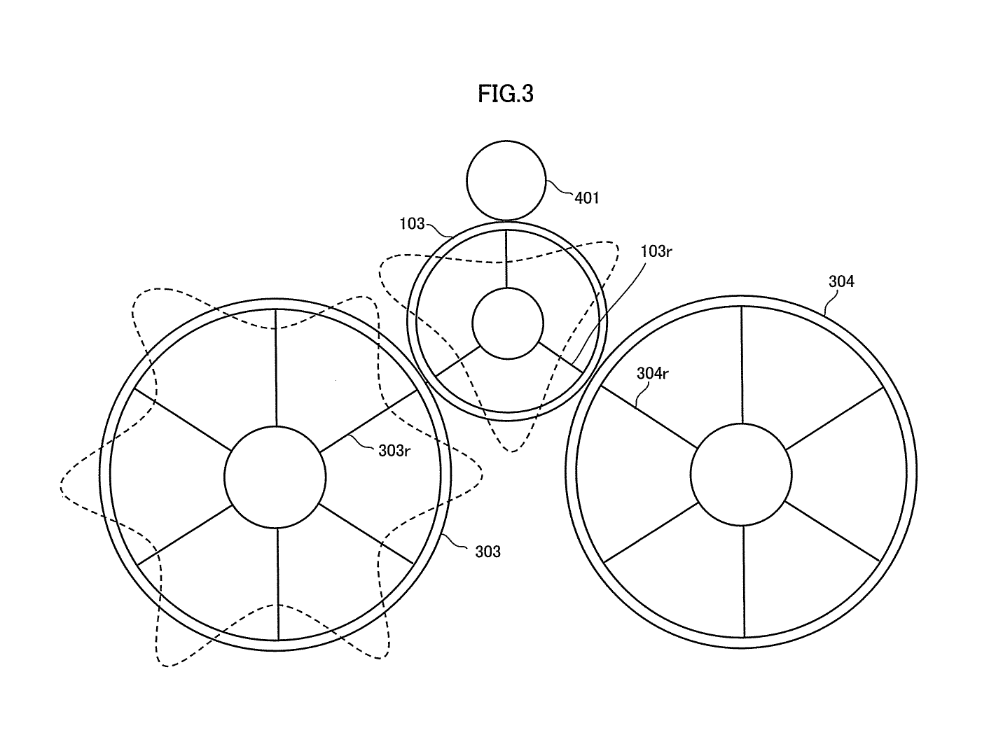

FIG. 3 is a view showing a detail of relationships between the idler gear 103 and the drum gear 303, and the drum gear 304. Hereinafter, the relationships between the idler gear 103 and the drum gear 303, and the drum gear 304, will be described as a representative example. The relationships are also established between all the idler gears and the drum gears.

The idler gear 103 (first gear) is a gear rotationally driven by a driving force transmitted from the motor gear 401. Three ribs 103r (first dimension setting units, first dimension setting means), which provide a predetermined effect to a dimension of the idler gear 103 in a radial direction of rotation, are provided at different positions (here, for every 120 degrees) of the idler gear 103 in a rotational direction. The number of teeth of the idler gear 103 here is assumed to be 66, for example.

The drum gear 303 (second gear) is a gear, which meshes with the idler gear 103, thereby a driving force is transmitted from the idler gear 103. The drum gear 303 rotationally drives the photoconductor drum 202C (first photoconductor drum) by the transmitted driving force. A plurality of ribs 303r (second dimension setting units, second dimension setting means), which provide a predetermined effect to a dimension of the drum gear 303 in a radial direction of rotation, are provided at positions in a rotational direction of the drum gear 303, the positions where the ribs 303r are in phase with the rib 103r at the time the drum gear 303 meshes with the idler gear 103. Here, the number of teeth of the drum gear 303 is assumed to be 132, for example.

The drum gear 304 (third gear) is a gear, which meshes with the idler gear 103, and thereby a driving force is transmitted from the idler gear 103. The drum gear 303 rotationally drives the photoconductor drum 202K (second photoconductor drum) by the transmitted driving force. A plurality of ribs 304r (third dimension setting units, third dimension setting means), which provide a predetermined effect to a dimension of the drum gear 304 in a radial direction of rotation, are provided at positions of the drum gear 304 in a rotational direction where the ribs 304r are in phase with the rib 103r at the time the drum gear 304 meshes with the idler gear 103. Here, the number of teeth of the drum gear 304 is assumed to be 132, for example.

That is, when the number of teeth of the idler gear 103 is Zi, the number of the ribs 103r is mi, the number of teeth of the drum gear 303 is Zd, and the number of ribs 303r is md, the following formula is obtained:

$$\begin{matrix}md = ( Zd / Zi ) \times mi \\ = ( 132 / 66 ) \times 3 \\ = 6\end{matrix}$$

From the formula, the number of ribs provided in the drum gear 303 (and the drum gear 304) is 6. By setting the number of ribs of gears adjacent to and meshing with each other in this way, at the time when the gears mesh with each other, the ribs of the gears adjacent to each other are always in a state where the ribs are in phase with each other between the gears.

The drum gears 301 to 304 and the idler gears 101 to 103 have different dimensions in a radial direction between positions where the ribs are formed and where ribs are not formed in the rotational direction, due to effects of time required for solidification at resin molding and heat contraction, which are characteristics of resin molded materials. Here, the “ribs” play a role of reinforcing strength of the gears in the radial direction of rotation. The ribs distort the gears in a way that angular positions where the ribs are formed have smaller radius than other angular positions (providing a “predetermined effect”), due to the effect of the heat contraction described above. In other words, in angular positions in the rotational direction of the gears where the ribs are not formed, the gears are distorted in a way that angular positions where the ribs are not formed have larger radius than other angular positions (corresponding to “predetermined effect”). In FIG. 3, the distortion of a pitch circle of the gears resulted from placement of the ribs as described above is shown by broken lines.

In case that form fluctuations of the idler gears are not in an ideal sine wave of three cycles per rotation, the angular speed of the drum gears can be maintained constant if the following relationship is established at points driving is transmitted between the idler gears and the drum gears. At the points where drive is liked, when the radius of the idler gears is larger than the normal value, the speed in a tangential direction transmitted from the idler gears to the drum gears becomes larger than the normal value. At this time, if the drum gears mesh with the idler gears at the points where the radius of the drum gears is larger than the normal value, the angular speed of the drum gears becomes smaller than the normal value. When an relationship is inverse to the above relationship, a similar idea can be established. By repeating these relationships alternately, the angular speed of a drum axis is constant without fluctuations.

In this way, by intentionally placing the ribs and the notches, errors in the outline form of the gears can be generated at intended positions, and thereby the entire driving system is configured to cancel fluctuations in speed. At the drive link points where the idler gears are linked to the drum gears in multiple of about 120 degrees, drive input points and drive output points of the idler gears are constantly worked to have speeds to cancel fluctuations in speed. That is, when drive is input at the points where the radius of the idler gears is large, the angular speed of the idler gears becomes small. At this time, if the radius of the idler gears at the drive output points is large, the speed in a tangential direction transmitted to the drum gears becomes large, and the fluctuations in speed in the idler gears are canceled.

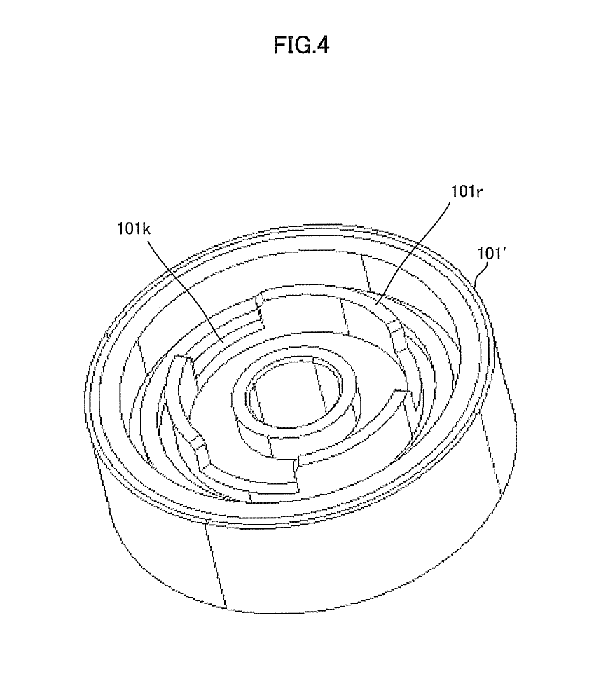

In the embodiment described above, the configuration is such that the ribs are provided as a means to provide the “predetermined effect” to the dimension of the gears in the rotational direction. However, the present invention is not limited thereto. For example, a plurality of notches (corresponding to the first and the second dimension setting units) may be provided to different positions of the gears in the rotational direction. FIG. 4 is a view showing a state in which three notches 101k are provided at different positions of an idler gear 101′ in a rotational direction. In this manner, providing the notches means, at the same time, providing three ribs 101r. As a matter of course, when the notches are provided to the idler gear, the notches desire to be placed at positions of the drum gear side, the positions where the notches of the gears are in phase between gears in a similar manner.

In addition, apart from the above, as the means to provide the “predetermined effect” to the dimension of the gears in the rotational direction, a plurality of resin injection gates (corresponding to the first and the second dimension setting units) may be provided at different positions of the gears in the rotational direction. The resin injection gates play a role of a resin injection inlet to resin-mold gears. The way of distortion at the time of heat contraction of the gears becomes different depending on how the resin injection gates are placed.

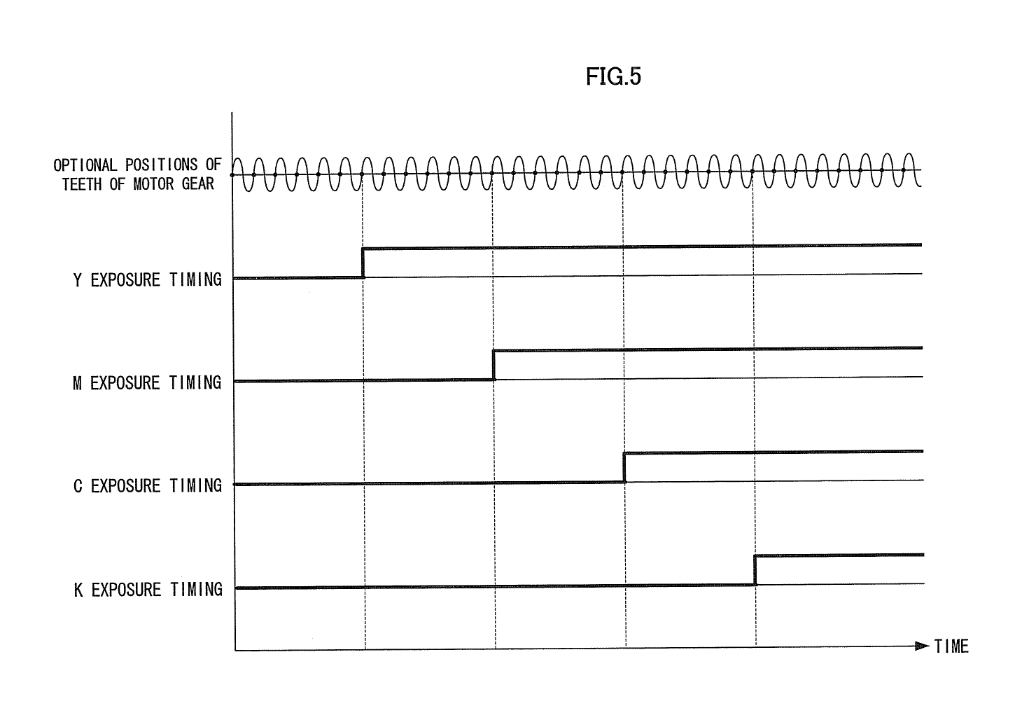

The numbers of teeth of the motor gear 401, the idler gear 103 (first gear), the drum gear 303 (second gear), and the drum gear 304 (third gear) are set so that the exposure start timing of the photoconductor drum 202C (first photoconductor drum) and the exposure start timing of the photoconductor drum 202K (second photoconductor drum) are shifted for n-cycles (n is an integer) of the motor gear at an image forming operation of the image forming device M. To describe more specifically, the number of teeth of the motor gear 401 is 21 in the present embodiment. As shown in FIG. 5, the exposure start timing of the photoconductor drum of each color in the present embodiment is set so as to be shifted for six cycles of the motor gear 401 from one another.

In general, there is a case where the ribs and the notches are difficult to be provided to the motor gear due to a relationship in size, etc. Therefore, in order to reduce the influence of form errors the motor gear originally has on an image as much as possible, the exposure timing of the photoconductor drums of each color is always set at an interval of predetermined cycles of the motor gear. Thereby, fluctuations in speed of the drums resulted from a change in form of a mounting face of a motor and the decentering of the motor gear can be in phase with each other when the image is moved for a distance between stations. In this manner, a shift in forming positions of a toner image with respect to the photoconductor drum of each color (color slipping on the image) can be inhibited.

In the embodiment described above, there is shown an example where a gear ratio (reducing ratio) between the idler gear (first gear) 103 and the drum gear (second gear) 303 and a gear ratio between the idler gear (first gear) 103 and the drum gear (third gear) 304 are set in the same ratio. However, as described above, the gear ratio between the idler gear 103 and the drum gear 303 and the gear ratio between the idler gear 103 and the drum gear 304 may be different, as long as the ribs, the notches, the resin injection gates, etc. in the rotational direction, which provide the predetermined effect to the size of the gears in the radial direction of rotation, are in phase with each other. Nevertheless, even in this case, in order that the dimension setting units, such as ribs, are in phase with each other, the number of the dimension setting units in the drum gear 303 and the number of the dimension setting units in the drum gear 304 are desired to be an integer multiple of the number of the dimension setting units of the idler gear 103.

In addition, in the embodiment described above, there is shown an example where the dimension setting units provided on the side of the first gear and the dimension setting units provided on the side of the second and the third gear are similar (the ribs are provided to both of gears placed adjacent to each other, etc). However, the present invention is not limited thereto, and any means may be used as long as such means provides a similar effect to the distortion of the gears in the radial direction of rotation. For example, the configuration may be such that a plurality of the resin injection gates are provided at predetermined positions on the side of the first gear in the rotational direction, and the ribs are provided on the side of the second and the third gears in a way that the ribs are in phase with the resin injection gates.

In addition, in the present embodiment, there is shown the configuration where a driving force is transmitted to the idler gear as the first gear from the motor gear. However, the present invention is not limited thereto. The configuration may be such that a driving force is transmitted to the idler gear as the first gear from the drum gear which meshes with the idler gear.

As described above, according to the present invention, by devising forms of gears by the number of the ribs of the gears and the number of the inside notches, the errors in the outline form of the gears can be generated in an intended cycle. Also, fluctuations in angular speed of drums resulted from the errors in the outline form of the gears can always be generated in the same cycle. Further, an amplitude of fluctuations in angular speed of drums can be restricted to be small, and the color slipping resulted from the fluctuations in angular speed of drums can be reduced.

In addition, in the present embodiment, there is shown an example where a plurality of the photoconductor drums are rotationally driven by the driving force transmitting device of the present embodiment. However, the present invention is not limited thereto. The present invention is applicable as long as a plurality of driving targets are synchronized with high precision and driven by gears.

In addition, according to the present embodiment, there can be provided a driving force transmitting method of the driving force transmitting device, which includes the first and the second gears, and transmits a driving force from one of the first and the second gears to the other, the method including: providing a plurality of the first dimension setting units, which provide the predetermined effect to the dimension of the first gear in the radial direction of rotation, at different positions of the first gear in the rotational direction; and providing a plurality of the second dimension setting units, which provide the predetermined effect to the dimension of the second gear in the radial direction of rotation, at positions where the second setting units are in phase with the first setting units of the second gear in the rotational direction at the time when the second gear meshes with the first gear.

In addition, in the driving force transmitting method of the configuration described above, when the number of teeth of the first gear is Zi, the number of the first dimension setting units is mi, the number of teeth of the second gear is Zd, and the number of the second dimension setting units is md, a relationship of md=(Zd/Zi)×mi desires to be obtained. In addition, in the driving force transmitting method of the configuration described above, the first and the second dimension setting units are desired to be the ribs for reinforcing strength of the gears in the radial direction of rotation. In addition, in the driving force transmitting method of the configuration described above, the first and the second dimension setting units may be the notches. In addition, in the driving force transmitting method of the configuration described above, the configuration may be such that the first and the second dimension setting units are the resin injection gates for resin-molding the gears.

Although the present invention has been described in detail by using specific embodiments, it is obvious to one skilled in the art that a variety of modifications and amendments can be made without departing from the spirit and the scope of the present invention.

As described above in detail, according to the present invention, a technology capable of inhibiting generation of errors in a rotational speed of each of the gears resulted from errors in the form thereof in a driving force transmission using a plurality of the gears can be provided.

What is claimed is:

1. A driving force transmitting device comprising:
a first gear rotationally driven by a transmitted driving force, the first gear in which a plurality of first dimension setting units providing a predetermined effect to a dimension of the first gear in a radial direction of rotation are provided in different positions of the first gear in a rotational direction; and
a second gear rotationally driven by a driving force which is transmitted from the first gear when the second gear meshes with the first gear, the second gear in which a plurality of second dimension setting units providing the predetermined effect to a dimension of the second gear in a radial direction of rotation are provided in positions of the second gear in a rotational direction, the positions where the second dimension setting units are in phase with the first dimension setting units at the time the second gear meshes with the first gear.

2. The driving force transmitting device according to claim 1, wherein,
when the number of teeth of the first gear is Zi, the number of the first dimension setting units is mi, the number of teeth of the second gear is Zd, and the number of the second dimension setting units is md, the driving force transmitting device has a relationship of the following formula:
md=(Zd/Zi)×mi

3. The driving force transmitting device according to claim 1, wherein
the first and the second dimension setting units are ribs for reinforcing strength of the gears in a radial direction of rotation.

4. The driving force transmitting device according to claim 1, wherein
the first and the second dimension setting units are notches.

5. The driving force transmitting device according to claim 1, wherein
the first and the second dimension setting units are resin injection gates for resin-molding the gears.

6. An image forming device, which forms an image to a sheet by rotationally driving a plurality of photoconductor drums, each of which forms a toner image of a color different from one another, the device comprising:
a first gear rotationally driven by a transmitted driving force, the first gear in which a plurality of first dimension setting units providing a predetermined effect to a dimension of the first gear in a radial direction of rotation are provided in different positions of the first gear in a rotational direction;
a second gear rotationally driving a first photoconductor drum by a driving force, which is transmitted from the first gear when the second gear meshes with the first gear, the second gear in which a plurality of second dimension setting units providing the predetermined effect to a dimension of the second gear in a radial direction of rotation are provided in positions of the second gear in a rotational direction, the positions where the second dimension setting units are in phase with the first dimension setting units at the time the second gear meshes with the first gear; and
a third gear rotationally driving a second photoconductor drum by a driving force, which is transmitted from the first gear when the third gear meshes with the first gear, the third gear in which a plurality of third dimension setting units providing the predetermined effect to a dimension of the third gear in a radial direction of rotation are provided in positions of the third gear in a rotational direction, the positions where the third dimension setting units are in phase with the first dimension setting units at the time the third gear meshes with the first gear.

7. The image forming device according to claim 6, wherein
the image forming device comprises a motor having a motor gear for rotationally driving the plurality of the photoconductor drums, and
the number of teeth of the motor gear, the first gear, the second gear, and the third gear are set so that an exposure start timing of the first photoconductor drum and an exposure start timing of the second photoconductor drum at an image forming operation are shifted for n-cycles (n is an integer) of the motor gear.

8. The image forming device according to claim 6, wherein,
when the number of teeth of the first gear is Zi, the number of the first dimension setting units is mi, the number of teeth of the second or the third gear is Zd, and the number of the second or the third dimension setting units is md, the image forming device has a relationship of the following formula:
md=(Zd/Zi)×mi

9. The image forming device according to claim 6, wherein
the first, the second, and the third dimension setting units are ribs for reinforcing strength of the gears in a radial direction of rotation.

10. The image forming device according to claim 6, wherein
the first, the second, and the third dimension setting units are notches.

11. The image forming device according to claim 6, wherein
the first, the second, and the third dimension setting units are resin injection gates for resin-molding the gears.

12. A driving force transmitting device comprising:
a first gear rotationally driven by a transmitted driving force, the first gear in which a plurality of first dimension setting means providing a predetermined effect to a dimension of the first gear in a radial direction of rotation are provided in different positions of the first gear in a rotational direction; and
a second gear rotationally driven by a driving force which is transmitted from the first gear when the second gear meshes with the first gear, the second gear in which a plurality of second dimension setting means providing the predetermined effect to a dimension of the second gear in a radial direction of rotation are provided in positions of the second gear in a rotational direction, the positions where the second dimension setting means are in phase with the first dimension setting means at the time the second gear meshes with the first gear.

13. The driving force transmitting device according to claim 12, wherein,
when the number of teeth of the first gear is Zi, the number of the first dimension setting means is mi, the number of teeth of the second gear is Zd, and the number of the second dimension setting means is md, the driving force transmitting device has a relationship of the following formula:
md=(Zd/Zi)×mi

14. The driving force transmitting device according to claim 12, wherein
the first and the second dimension setting means are ribs for reinforcing strength of the gears in a radial direction of rotation.

15. The driving force transmitting device according to claim 12, wherein
the first and the second dimension setting means are notches.

16. The driving force transmitting device according to claim 12, wherein
the first and the second dimension setting means are resin injection gates for resin-molding the gears.
